(19) United States
(12) Patent Application Publication
(10) Pub. No.: US 2025/0061693 A1
(43) Pub. Date: Feb. 20, 2025

(54) Simulated Optical Histopathology from Hyperspectral Chemical Imagery

(71) Applicant: The Board of Trustees of the University of Illinois, Urbana, IL (US)

(72) Inventors: Rohit Bhargava, Urbana, IL (US); Kianoush Falahkheirkhah, Urbana, IL (US); Sudipta S. Mukherjee, Savoy, IL (US)

(73) Assignee: The Board of Trustees of the University of Illinois, Urbana, IL (US)

(21) Appl. No.: 18/806,443

(22) Filed: Aug. 15, 2024

Related U.S. Application Data
(60) Provisional application No. 63/519,995, filed on Aug. 16, 2023.

(51) Int. Cl. G06V 10/774; G01N 21/65; G06T 11/00; G06V 10/143; G06V 10/776; G06V 20/69

(52) U.S. Cl. CPC G06V 10/774; G01N 21/65; G06T 11/00; G06V 10/143; G06V 10/776; G06V 20/693; G01N 2021/655; G06T 2210/41

(57) ABSTRACT

Embodiments are provided for determining simulated optical microscopy images of formalin-fixed paraffin embedded (FFPE) stained tissue samples from stimulated Raman scattering microscopy (SRSM) images of frozen tissue samples. These embodiments include applying the SRSM images to a first generative model to generate simulated optical microscopy images of thawed, stained tissue samples corresponding to the SRS imaged tissue samples. The simulated optical microscopy images are then applied to a second generative model to generate simulated FFPE microscopy images of the frozen tissue samples. Training methods are also provided to (i) generate the first generative model using paired training datasets of SRSM images and optical microscopy images of thawed, stained tissue samples, with each SRSM image depicting the same respective tissue sample as a corresponding optical microscopy image; and (ii) generate the second generative model using a training dataset of FFPE microscopy images and images output from the first generative model.

### CROSS-REFERENCE TO RELATED APPLICATION

This application claims priority to U.S. provisional application No. 63/519,995, filed Aug. 16, 2023, the contents of which are hereby incorporated by reference.

### STATEMENT REGARDING FEDERALLY SPONSORED RESEARCH OR DEVELOPMENT

This invention was made with government support under R21 CA263147 awarded by the National Cancer Institute of the National Institutes of Health. The government has certain rights in the invention.

### BACKGROUND

It is desirable in many applications to be able to quickly generate microscopic images of tissue samples for histopathological analysis. Such imaging and analysis can facilitate the diagnosis, typing, and/or staging of disease, the assessment of the efficacy of a treatment and/or the need for additional treatment, or the performance of other scientific and/or medical tasks.

### SUMMARY

In a first aspect, a method is provided that includes: (i) obtaining a first training dataset that includes stimulated Raman scattering microscopy (SRSM) images of frozen tissue samples; (ii) obtaining a second training dataset that includes optical microscopy images of thawed, stained tissue samples, wherein each optical microscopy image of the second training dataset depicts a respective same frozen tissue sample as a corresponding SRSM image of the first training dataset; (iii) using the first training dataset and the second training dataset to train a first generative model to generate, from input SRSM images of frozen tissue samples, output model-generated images of thawed, stained tissue samples; (iv) using the trained first generative model, generating a third training dataset that includes model-generated optical microscopy images of thawed, stained tissue samples; (v) obtaining a fourth training dataset that includes formalin-fixed paraffin embedded (FFPE) microscopy images of FFPE tissue samples; and (vi) using the third training dataset and the fourth training dataset to train a second generative model to generate, from input microscopy images of thawed, stained tissue samples, output model-generated images of FFPE tissue samples.

In a second aspect, a article of manufacture is provided that includes a computer-readable medium having stored thereon program instructions that, upon execution by a computing device, cause the computing device to perform operations to effect a method that includes: (i) applying a stimulated Raman scattering microscopy (SRSM) image of a frozen tissue sample to a first generative model to generate an intermediate image, wherein the first generative model has been trained to generate, from input SRSM images of frozen tissue samples, output model-generated optical microscopy images of thawed, stained tissue samples; and (ii) applying the intermediate image to a second generative model to generate a model-generated formalin-fixed paraffin embedded (FFPE) microscopy image of the frozen tissue sample, wherein the second generative model has been trained to generate, from input optical microscopy images of thawed, stained tissue samples, output model-generated images of FFPE tissue samples.

In a third aspect, an article of manufacture is provided that includes a computer-readable medium having stored thereon program instructions that, upon execution by a computing device, cause the computing device to perform operations to effect a method that includes: applying a stimulated Raman scattering microscopy (SRSM) image of a frozen tissue sample to a generative model to generate a model-generated formalin-fixed paraffin embedded (FFPE) microscopy image of the frozen tissue sample, wherein the generative model has been trained to generate, from SRSM images of frozen tissue samples, output model-generated images of FFPE tissue samples.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, process steps can be rearranged, combined, distributed, eliminated, or otherwise changed, while remaining within the scope of the embodiments as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are included to provide a further understanding of the system and methods of the disclosure and are incorporated in and constitute a part of this specification. The drawings illustrate one or more embodiment(s) of the disclosure, and together with the description serve to explain the principles and operation of the disclosure.

FIG. 1A depicts aspects of an example method, according to example embodiments.

FIG. 1B depicts aspects of an example method, according to example embodiments.

FIG. 1C depicts aspects of an example method, according to example embodiments.

FIG. 1D depicts aspects of an example method, according to example embodiments.

FIG. 2A depicts aspects of an example method, according to example embodiments.

FIG. 2B depicts aspects of an example method, according to example embodiments.

FIG. 2C depicts aspects of an example method, according to example embodiments.

FIG. 3A depicts aspects of an example method, according to example embodiments.

FIG. 3B depicts experimental results.

FIG. 3C depicts experimental results.

FIG. 3D depicts experimental results.

FIG. 4A depicts experimental results.

FIG. 4B depicts experimental results.

FIG. 4C depicts experimental results.

FIG. 5A depicts experimental results.

FIG. 5B depicts experimental results.

FIG. 6A depicts experimental results.

FIG. 6B depicts experimental results.

### DETAILED DESCRIPTION

### I. Overview

It is generally desirable to obtain microscopic images of tissue samples for histopathological analysis or other scientific or medical applications. It is also desirable to reduce the intrusiveness of accessing such samples, to reduce the cost, time, and sample damage or alteration attendant to the imaging of such samples, and to increase the quality of such images and the types of data represented thereby. For example, it can be beneficial to reduce the time to prepare and image such samples so that the preparation, imaging, and analysis can occur during a surgical intervention (“intra-operative” imaging), allowing the results of the imaging and analysis to guide the performance of the surgical intervention (e.g., to inform the removal of additional tissue along the margin of a tumor, to increase the likelihood that all of the tumor is removed). It is also generally desirable for the sample preparation and imaging techniques to be compatible with existing analysis methods and the expectations and experience of pathologists so that the pathologists can apply their existing expertise and clinical data to the image data to generate accurate diagnostic conclusions.

One common sample imaging method is formalin-fixed paraffin embedded (FFPE) microscopic imaging. In this method, samples are carefully prepared via techniques that result in high-quality stained images of the morphology of thin slices of the sample. However, this method is expensive, takes a protracted period of time, requires the skills of highly trained technicians, and abolishes some of the chemical information present in the sample (e.g., lipids or related chemical contents). Another common sample imaging method is fresh frozen (FF) imaging. In this method, samples are frozen in order to be sectioned prior to staining. This method is quicker and less resource intensive than FFPE. However, FF also exhibits increased imaging artifacts relating, e.g., to distortion of the frozen sample slices as they are sliced. Staining and other processes attendant to either method can preclude additional subsequent analyses (e.g., due to chemical modification of the samples by the stains and/or the stains optically obscuring other image information present in the sample).

Stimulated Raman scattering (SRS) microscopy is a relatively new multi-photon imaging modality that generates hyperspectral data about the chemical contents of a sample. Such information may be useful for diagnostic imaging, e.g., to identify whether cancerous tissue is present in a sample. SRS microscopy is also fast, allowing sample preparation and imaging to be performed quickly enough for the image data to be used intra-operatively. Additionally, SRS is able to optically section tissue samples, allowing for thicker sample slices to be prepared (thereby reducing the cost and complexity of generating such samples, as well as potentially reducing the distortion of the samples during preparation and imaging of the samples). Optical sectioning also allows multiple SRS images to be taken at multiple different image planes within such a thicker sample, allowing the sample to be more completely volumetrically scanned for, e.g., cancerous tissue or other tissue of interest.

While the hyperspectral image data generated by SRS microscopy is potentially highly informative, it is unfamiliar to pathologists. Fortunately, the image information generated by SRS is sufficient to accurately predict the pattern of staining that would occur if an SRS-imaged sample was stained. The methods described herein facilitate the training and use of generative models to generate simulated FFPE images based on SRS image data. This allows the benefits of SRS to be obtained (e.g., fast, simple sample preparation and imaging that provides extensive information about the chemical content of samples) while also allowing histopathologists to analyze images that are similar to familiar types of FFPE images (e.g., hematoxylin and eosin (H&E)-stained FFPE images). Additionally, the sample preparation methods used to prepare a sample for SRS imaging, which include fresh freezing and then sectioning the sample, permit subsequent analyses to be performed on the sample that might not be available if the sample had instead been subject to staining and/or FFPE preparation steps.

Training image datasets that include SRS microscopy images and FFPE microscopy images can be employed to train such a generative model. In practice, it can be difficult to obtain training datasets of sufficient size and quality to facilitate training of a single model to generate simulated FFPE images directly from input SRS images. To relax these requirements, allowing less training data to be used, training data of lesser quality to be used, and/or the model to be trained in less time/fewer processor cycles/using less power, the generative model could be separated into two or more sub-models. For example, a first generative sub-model could generate simulated microscopy images of samples that have been fresh frozen, thawed, and then stained (e.g., with H&E) from SRS microscopy images. A second generative model could then receive the output simulated microscopy image from the first model and generate therefrom a simulated FFPE microscopy image.

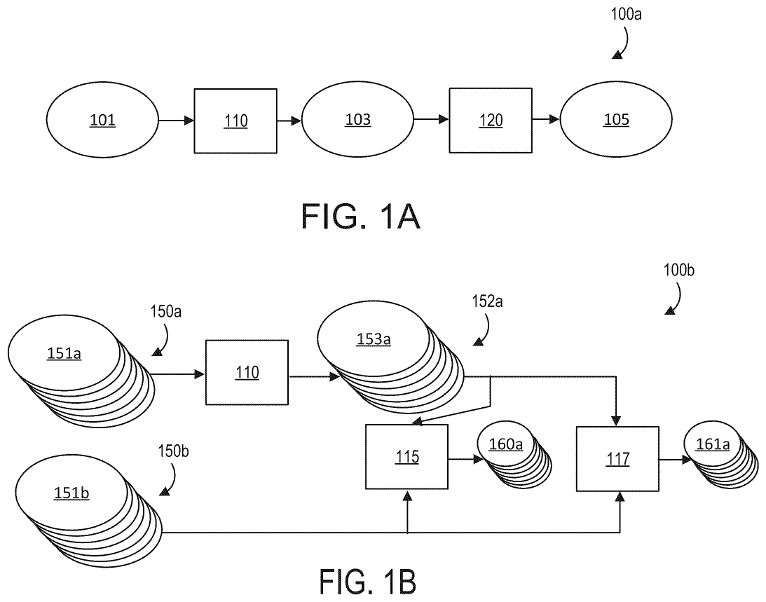

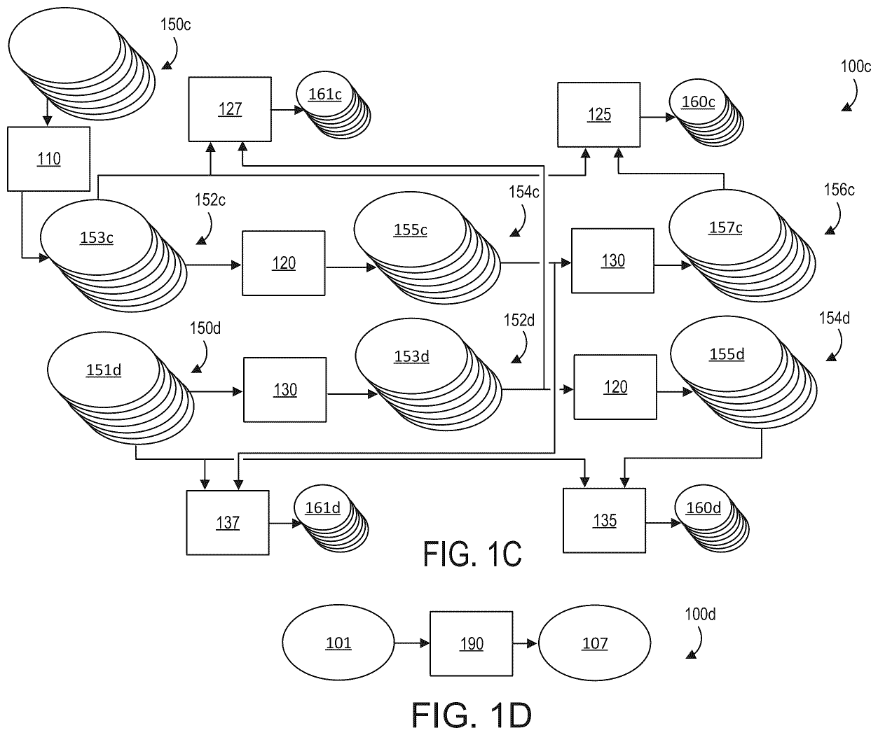

FIG. 1A depicts aspects of an example method 100a as described above for using two generative models to predict an output simulated FFPE microscopy image 105 from an input SRS microscopy (SRSM) image 101. The SRSM image 101 is applied to a first generative model 110 to generate an intermediate image 103. The first generative model 110 has been trained to generate, from input SRSM images of frozen tissue samples, output model-generated optical microscopy images of thawed, stained tissue samples. The intermediate image 103 is then applied to a second generative model 120 to generate the output FFPE microscopy image 105. The second generative model 120 has been trained to generate, from input optical microscopy images of thawed, stained tissue samples, output model-generated images of FFPE tissue samples.

The output image 105, once generated, could be provided on a display (e.g., to a histopathologist on a display of a histopathology workstation). Such a display could also include the results of other analyses performed on the input SRSM image 101, e.g., analyses of the lipid content of the sample represented by the input SRSM image 101. This allows the single sample to provide information in excess of what would have been possible if the sample had been subjected to FFPE sample preparation and analysis, because the SRS imaging process permits additional chemical information about the sample to be imaged, and also because the sample can be thawed following SRS imaging and subjected to further analyses (such analyses being potentially eliminated by the sample having been subjected to FFPE processes, staining, or other related imaging and sample preparation processes). Additionally, since SRS imaging includes optical sectioning, and uses wavelengths of infrared light that have improved sample penetration relative to, e.g., optical wavelengths, SRS imaging can be performed on thicker tissue slices (e.g., a slice having a thickness greater than 50 microns, or greater than 150 microns) that are easier, quicker, and cheaper to prepare and that are less likely to exhibit artifacts related to slicing or other sample preparation processes.

The inference method 100a could be performed locally, in the same room or building as the imaging apparatus used to generate the SRSM images. For example, one or more processors of the SRS imaging apparatus could perform the method 100a, or a server in the same building as the SRS imaging apparatus (e.g., a Picture Archiving and Communication System (PACS) system) could perform the method 100a. Alternatively, the method 100a could be performed remotely, e.g., in a cloud computing environment. In such examples, generated SRSM images could be transmitted (e.g., from an SRS imaging apparatus) to the remote system(s), and the results of the performance of the method 100a (e.g., model-generated FFPE images) could then be transmitted back from the remote system(s).

Such a first model could be trained with paired sets of training images, each pair including an SRS image and a stained optical image of the same sample (e.g., images of neighboring or otherwise nearby slices of the same sample, or images of the same slice of the same sample). This allows the first model to learn the underlying mapping between chemical contents (as represented by the SRS hyperspectral image data) of a sample and the corresponding pattern of staining of those contents by a desired stain (e.g., H&E) by using paired images (one SRS image of the frozen sample, and one optical of the sample following thawing and staining of the same slice/sample used to generate the SRS image). The use of such paired images allows the first model to learn the mapping accurately and quickly, using relatively fewer training images of relatively lower quality and that can be obtained quickly and cheaply.

The second model can then be trained, based on unpaired sets of optical images of thawed stained samples and optical images of FFPE stained samples, to correct common defects caused by the freezing and other sample preparation steps used to generate SRS images and to predict the sort of high-fidelity morphological information that is present in FFPE images. Since the first model provides the initial information about the structure of specific input sample SRS images, the second model can be trained to learn such a task accurately and quickly with fewer ‘hallucinations,’ using relatively fewer training images that are non-paired. To facilitate this training using un-paired sets of training images, the second model can be trained together with a third generative model, with the second model being trained to generate FFPE microscopy images from thawed, stained microscopy images generated by the first model and the third model trained to perform the opposite prediction (i.e., to generate thawed, stained microscopy images from FFPE microscopy images).

Such a training structure allows the ends of a series of generative predictions (e.g., FFPE image to simulated thawed, stained image to doubly-simulated FFPE image) to be directly compared to provide loss information for training the second and third models (e.g., a mean squared pixel-wise loss function between an input image and a doubly-simulated output image). Such loss information can be augmented by loss information output from discriminator models trained together with the second and third models to predict which of two input images is a ‘real’ input image (either a real FFPE microscopy image or a simulated thawed, stained microscopy image generated by the first model) and which is an output generated by one or the other of the second or third models.

FIG. 1B depicts aspects of a method 100b for training the first model in such a two-model structure (i.e., the model that generates simulated optical microscopy images of thawed, stained tissue samples from input SRS microscopy images). The method uses a first training dataset 150a of SRSM images (which includes a particular SRSM training image 151a) and a second training dataset 150b of microscopy images of thawed, stained tissue samples (which includes a particular stained thawed training image 151b). The images in the training datasets 150a, 150b are paired such that each image in the first training dataset 150a depicts a respective same frozen tissue sample as a corresponding image of the first training dataset 150b. So, for example, image 151a and image 151b depict the same tissue sample. This could include pairs of corresponding images depicting different slices of the same sample (e.g., immediately adjacent slices, or slices that are otherwise nearby) or the same slice of the same sample (e.g., by SRS imaging the frozen slice, then thawing, staining, and otherwise preparing the slice for imaging to generate the corresponding stained thawed training image).

Images of the first training dataset 150a are applied to the first model 110 being trained to generate intermediate images 152a that are model-generated optical microscopy images of thawed, stained tissue samples. These intermediate images 152a can then be compared to corresponding images of the second training dataset 150b (e.g., a particular intermediate image 153a that was generated by applying image 151a to the first model 110 can be compared to image 151b). These comparisons result in the generation of loss values/information (e.g., 160a, 161a) that can be used to update or otherwise train the first model 110.

Comparing intermediate images 152a to corresponding images of the second training dataset 150b can include performing a pixel-wise comparison. For example, a mean squared error, sum of squared error, sum of errors, or some other loss function 115 could be applied pixel-wise to corresponding pixels of an intermediate image (e.g., 153a) and its corresponding image of the second training dataset (e.g., 151b) to generate a loss value 160a. Additionally or alternatively, Comparing intermediate images 152a to corresponding images of the second training dataset 150b can include applying those images to a discriminator model 117 to predict which of the two applied images is a ‘true’ microscopy image of a thawed, stained tissue sample and which was generated by the first model 110; the accuracy of that prediction could be used as, or used to determine, a loss value 161a. The discriminator model 117 could be trained together with the first model 110 based on the loss values generated therefrom. The training of the first model 110 could be performed in stages. For example, a first stage of training (e.g., for 50000 training iterations) could be based only on the pixel-wise comparison loss values. A subsequent second stage of training could be based on both the pixel-wise comparison loss values and the discriminator model comparison loss values.

Updating the model 110 based on the loss values 160a and/or 161a could be performed based on single loss values (or pairs of loss values 160a, 161a where both comparison methods are being used). Alternatively, the model 110 could be updated in a batched fashion, with the method 110b being performed for a number of pairs of images of the first 150a and second 150b training datasets to generate corresponding sets of loss values 160a, 161a and those sets of loss values used to update the first model 110 together.

FIG. 1C depicts aspects of a method 100c for training the second model in a two-model structure as described herein (i.e., the model that generates simulated FFPE microscopy images of tissue samples from input optical microscopy images of thawed, stained tissue samples). The method uses a third training dataset 152c of optical microscopy images of thawed, stained tissue samples (which includes a particular training image 153c) and a fourth training dataset 150d of FFPE microscopy images (which includes a particular FFPE training image 151d). The images of the third training dataset 152c could be model-generated, as shown in FIG. 1C, by the first model 110 based on a training dataset 150c of SRSM images; additionally or alternatively, the third training dataset 152c could include real optical microscopy images of thawed, stained tissue samples.

The images in the training datasets 152c, 150d may be unpaired. In order to train the second model 120 without paired training images, the second model 120 can be trained together with a third model 130 that is trained to generate, from input images FFPE tissue samples, output model-generated microscopy images of thawed, stained tissue samples. Such second 120 and third 130 models could then be used serially to generate pairs of images of the same type (e.g., images of FFPE samples, or optical images of thawed, stained samples) that can then be compared, in a pixel-wise fashion, to generate loss information to train the models 120, 130. Intermediate model-generated images can also be applied to discriminator model(s) to compare with images of the corresponding training datasets 152c, 150d to provide additional loss information for training the models 120, 130.

Aspects of such a training method are depicted by way of example in FIG. 1C. A particular training image 153c of the third training dataset 152c can be applied to the second model 120 to generate a corresponding first model-generated FFPE microscopy image 155c. A particular training image 151d of the fourth training dataset 150c can be applied to the third model 130 to generate a corresponding first model-generated optical microscopy image 153d. The first model-generated optical microscopy image 153d can then be applied to the second model 120 to generate a second model-generated FFPE microscopy image 155d and the first model-generated FFPE microscopy image 155c can then be applied to the third model 130 to generate a second model-generated optical microscopy image 157c.

The second model-generated images 157c, 155d can then be compared to corresponding images of the fourth 150d and third 152c training datasets (e.g., second model-generated optical microscopy image 157c can be compared to particular training image 153c and second model-generated FFPE microscopy image 155d can be compared to particular training image 151d). These comparisons result in the generation of loss values/information (e.g., 161c, 161d) that can be used to update or otherwise train the models 120, 130. Such comparisons can include performing pixel-wise comparisons. For example, a mean squared error, sum of squared error, sum of errors, or some other loss function 125 could be applied pixel-wise to the second model-generated optical microscopy image 157c and the corresponding particular training image 153c to generate a loss value 160c. Additionally, a mean squared error, sum of squared error, sum of errors, or some other loss function 135 could be applied pixel-wise to the second model-generated FFPE microscopy image 155d and the corresponding particular training image 151d to generate a loss value 160d.

Additionally or alternatively, images can be compared between the training datasets. This can include applying pairs of images to discriminator models 127, 137 to predict which of a pair of applied images is an ‘input’ microscopy image and which was generated by one of the two generative models 120, 130 being trained; the accuracy of those predictions could be used as, or used to determine, loss values 161c, 161d for training the generative models 120, 130 and discriminator models 125, 135. One of the discriminator models 127 could predict which of two input images is an optical microscopy image of thawed and stained tissue from the third dataset 152c (e.g., 153c) and which was a simulated optical microscopy image of a thawed, stained sample generated by the third generative model 130 (e.g., 153d). The other of the discriminator models 137 could predict which of two input images is an FFPE microscopy image from the fourth dataset 150d (e.g., 151d) and which was a simulated FFPE image generated by the second generative model 120 (e.g., 155c).

Updating the models 120, 130, 127, 137 based on the loss values 160c, 160d, 161c, and/or 161d could be performed based on single sets of loss values 160c, 160d, 161c, 161d. Alternatively, the models 120, 130, 127, 137 could be updated in a batched fashion, with the method 110c being performed for a number of pairs of images of the third 152c and fourth 150d training datasets to generate corresponding sets of loss values 160c, 160d, 161c, 161d and those sets of loss values used to update the models 120, 130, 12, 137 together.

As an alternative to the two-model structure depicted above, a single model could be trained to generate simulated FFPE images directly from input SRS images. FIG. 1D depicts aspects of an example of such a method 100d for using a single generative model 190 to predict an output simulated FFPE microscopy image 107 from an input SRS microscopy (SRSM) image 101. Such a generative model 190 could be trained directly on training datasets of FFPE microscopy images and SRSM images. Additionally or alternatively, such a model 190 could be trained by distilling two generative models trained as described elsewhere herein (e.g., models 110, 120 trained using the methods 100b, 100c of FIG. 1B-C) into a single model 190 using, e.g., transfer learning or other model distillation techniques.

These as well as other aspects, advantages, and alternatives will become apparent to those of ordinary skill in the art by reading the Appendix to the Specification which contains additional example embodiments and experimental validation data. Further, it should be understood that the description provided in this summary section and elsewhere in this document is intended to illustrate the claimed subject matter by way of example and not by way of limitation.

### II. Experimental Results

Histopathology has remained a cornerstone for biomedical tissue assessment for over a century, with a resource-intensive workflow involving biopsy or excision, gross examination, sampling, tissue processing to snap frozen or formalin-fixed paraffin-embedded blocks, sectioning, staining, optical imaging and microscopic assessment. Emerging chemical imaging approaches, including Stimulated Raman Scattering (SRS) microscopy, can directly measure inherent molecular composition in tissue (thereby dispensing with the need for tissue processing, sectioning, and using dyes) and can use artificial intelligence (AI) algorithms to provide high-quality images. The experimental embodiments herein demonstrate the integration of SRS microscopy in a pathology workflow to rapidly record chemical information from minimally processed fresh frozen prostate tissue. Instead of using thin sections, data was recorded from intact thick tissues and optical sectioning was used to generate images from multiple planes. Then, a deep learning-based processing pipeline was used to generate virtual H&E images. Next, the computational method was extended to generate archival-quality images in minutes, which were equivalent to those obtained from hours/days-long formalin-fixed, paraffin-embedded processing.

Since the embodiments herein do not wash away lipids and small molecules, the utility of lipid chemical composition in determining grade was assessed. Together, the combination of chemical imaging and AI provides novel capabilities for rapid assessments in pathology by reducing the complexity and burden of current workflows.

The clinical identification and assessment of prostatic carcinoma is based on characteristic histomorphologic features observed by optical microscopy within prepared thin sections (approximately 5 μm, a single cell layer thick), cut onto glass slides prepared from processed tissue. In the path from tissue acquisition to thin sections, there are two principal methods of tissue processing in clinical practice: namely, formalin-fixed paraffin embedded (FFPE) and fresh frozen (FF). Each of these have advantages and drawbacks that affect the ability to interpret structural changes and make accurate determinations. FFPE sections have relatively higher contrast and well-preserved morphology, making them the gold standard for clinical diagnoses. The extended processing required for FFPE sections, however, typically requires a wait of hours to days for diagnoses. Further, solvents used for processing result in loss of lipids and small molecules. Formalin fixation induces molecular cross-links that make tissues highly stable and the results reproducible over long periods of time. However, this processing and cross-linking also renders samples sub-optimal for molecular analyses, particularly if the tissue is fixed in formalin for an extended period or as blocks age. FF processing, in contrast, preserves molecular content and involves minimal processing (in 15 to 30 minutes), potentially making it a preferred method for intraoperative pathologic assessment. Preparing samples in this manner, however, implicates the availability of significantly greater resources and highly skilled practitioners. Slides produced from FF processing often lack the quality of FFPE sections and may have much higher incidence of sample preparation artifacts. These factors can increase complexity in histomorphologic interpretation and lead to reduced diagnostic utility. Regardless of the processing method, tissue can be stained to generate appreciable microscopic contrast between the different cell types and extracellular matrix. The most common stain used clinically is hematoxylin and eosin (H&E), in which protein-rich regions are stained pink (eosin) and nucleic acid-rich regions are stained blue (hematoxylin). In addition to requiring reagents and labor, intra-laboratory and inter-laboratory variations in staining (over and under-staining), and batch variations often affect assessment. These variations are especially problematic in applying digital methods, resulting in the development and use of normalization or correction algorithms. Further, H&E staining generally renders the stained tissue unavailable for other imaging/analytical modalities, a particular issue when small disease foci need to be examined in limited tissue materials.

Herein, these shortcomings are addressed by considering the specific example case of prostate cancer (PCa). PCa is one of the most common male cancers in the US, with estimates of more than a quarter million diagnoses annually and second only to lung cancer in terms of mortality. PCa is histologically assessed using the Gleason grading system, which is not only the strongest predictor of outcome in men with PCa but is also one of the most durable and prototypical workflows in pathology. H&E images allow a distinction between epithelial cells and stroma as well as an appreciation of architectural glandular alterations used for cancer grading. The embodiments herein present a workflow for PCa pathology that seeks to maintain the diagnostic quality of current workflows but that considerably shortens the time and resources required for processing. The embodiments herein are based on a combination of two technologies-stimulated Raman scattering microscopy (SRSM) and deep learning (DL)-whose combined application rapidly generates high-quality, clinically-actionable images.

SRSM is a multiphoton optical microscopy technique that directly measures chemical composition of tissues arising from their Raman vibrational response while localizing the signal acquired from a region in tissue to dimensions of a few hundred nanometers. In addition to label-free molecular measurement, SRSM also allows optical depth sectioning in thicker samples due to multiphoton localization. The use of near-infrared lasers allows SRSM to probe deeper in tissue compared to optical microscopy, avoid photo-bleaching that may affect fluorescence-based methods, and is applicable to thick, freshly excised tissue that limits mid-infrared or ultraviolet microscopy. With a goal to decrease the time and effort to classical diagnostic histology images for evaluation by pathologists, the embodiments herein include workflows to record SRSM data using optical sectioning to assess large spatial regions of approximately single cell-thick planes (i.e., virtual sectioning) from FF tissue samples that are considerably thicker than conventional microtome-cut sections. The resulting hyperspectral datasets may b be difficult or impossible for pathologists to directly interpret and, thus, benefit from the application of artificial intelligence (AI) techniques as described herein. Relating to clinical and research practices, an active area for chemical imaging techniques is to use spectral information to generate realistic clinical images. Such spectra-to-stained image translation may be termed virtual, computational, or stainless staining.

Deep learning (DL) methods are attractive for this task due to their powerful prediction capability and relative ease of deployment. The embodiments herein make use of a sub-class of DL, namely generative adversarial networks (GAN), that have the capability to handle the non-linear transformation between two different domains to synthesize realistic images. GANs are used herein in the second part of the workflow involving generating clinical (FF and FFPE) images from unstained tissues' SRSM data. In summary, a first step involves generating H&E images from FF SRSM data. A second step involves generating virtual FFPE images from the virtual FF H&E images. Virtual FF staining can enable faster cancer detection and assessment of tumor margins compared to current intraoperative protocols whereas generating gold standard diagnostic quality FFPE virtual images from the same data can provide images for reliable diagnoses much earlier than current practice, thereby uniting the benefits of both approaches in one workflow.

The workflow described herein simplifies several steps in pathology-first, it may reduce the time from surgical or biopsy tissue acquisition to H&E images from days to minutes by eliminating numerous steps in contemporary clinical sample processing and staining. Reduction of processing tasks and effort could be especially beneficial for accelerating research as well as preserving the tissue for further tests that would be precluded by the staining or other processes involved in conventional FFPE image generation.

The ability to generate FFPE images can also be translated to in vivo measurements. Thick sections (˜100 μm) may be used that make the FF pathology process easier and faster, addressing the currently unmet need to accelerate the speed and quality of FF processing. Preparing thin sections (<10 μm) is laborious and implicates significant skill under intense time constraints for those applications where FF processing is most beneficial. FF processing can also often introduce artifacts due to cell swelling, ice crystal development, folded and lost tissue, and uneven staining, resulting in poor morphologic detail. Current methods are also not conducive to cutting thin sections from certain types of tissue, for example, breast tissue containing fat. These issues have resulted in an underutilization of intraoperative pathologic assessment to the detriment of patients in a variety of cancers. Since the approach described herein can be translated to other tissues and other venues, further, it can address these drawbacks in FF processing.

The embodiments herein also use the optical sectioning capability of SRSM to generate more than one image (at different depths) per thick section, and thus provide more data for interpretation by pathologists, other clinicians, and/or trained diagnostic machine learning models. The ability to assess tissue at greater depths can increase the sensitivity in detecting positive margins as well as for other assessments such as lymph node metastases in sentinel lymph nodes.

The embodiments herein can connect the FF and FFPE domains using AI from SRSM images. In general, good agreement was found between the diagnoses on traditional histologic sections and those made on the virtual sections. Since AI-powered imaging technology can record data without specialized reagents or the need for expert, multi-step manual processes, it can be used in a variety of laboratory contexts, from major academic medical centers to community centers. Thus, high quality pathology images can be obtained rapidly even in settings with fewer human or technical resources.

The embodiments herein involve a deep learning framework that facilitates faster pathologic evaluation of FF samples. Without any staining and additional processing of the tissues, the framework computationally converts multi-section SRS images of thick samples into H&E images and further into the multi-section virtual FFPE domain.

Although SRS imaging is discussed herein as an example, other label-free imaging modalities and contrast mechanisms such as infrared imaging, polarization imaging, and autofluorescence imaging can be applied to modified versions of the embodiments described herein. The same approach can also be applied to any other types of tissues or for generating different types of stains.

SRSM also has several key advantages over infrared absorption based chemical imaging such as Fourier transform Infrared and discrete frequency infrared imaging; including the ability to image wet tissues and higher axial and lateral diffraction-limited spatial resolutions at multiple depths. In comparison with non-DL based transformation methods, the embodiments herein are more robust to noise or stain variations, generate more realistic stained images and, after the training phase, can be fully automated. During the training phase, training the model may involve large and heterogeneous datasets, optimization of large number of hyper-parameters, and careful validation by expert pathologists.

Since the embodiments herein use light for analysis without adding stains or other chemical substances to the tissue sample being imaged, the tissue sample can be processed for traditional pathology or other workflows after imaging. More detailed chemical analysis can be conducted using SRSM itself as well. Cancer cells may have altered metabolic pathways to sustain the proliferative growth of tumor. Among others, de-novo lipogenesis and altered lipolysis are recognized as hallmarks of many forms of cancer including prostate cancer. This can be manifested in accumulation fatty acids in lipid droplets. Additionally, cholesteryl esters are reported to have a key role to play in disease progression in PCa and can be stored in the form of lipid droplets. The results herein show that while there is a large statistically significant difference between benign and cancerous glands, there is a smaller difference between low grade and high grade cancer (p=0.03), with low grades seemingly having more LD expression than high grade. The workflow proposed here can be used for rapid assessment of tissues and addressing such questions experimentally. Finally, since the imaging modality and the machine learning algorithms described herein are not specific to any tissue type, the proposed workflow may find broad utility for both clinical and research purposes in other types of cancer and/or other biological disorders, diseases, and/or systems of interest.

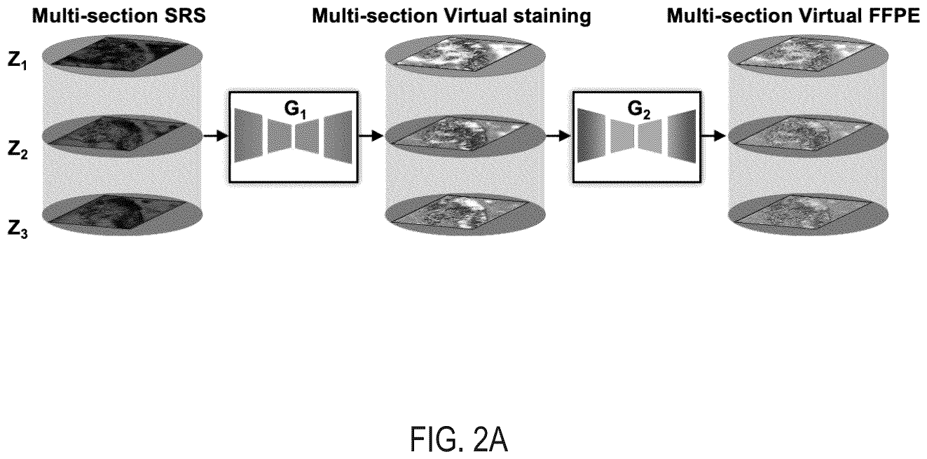

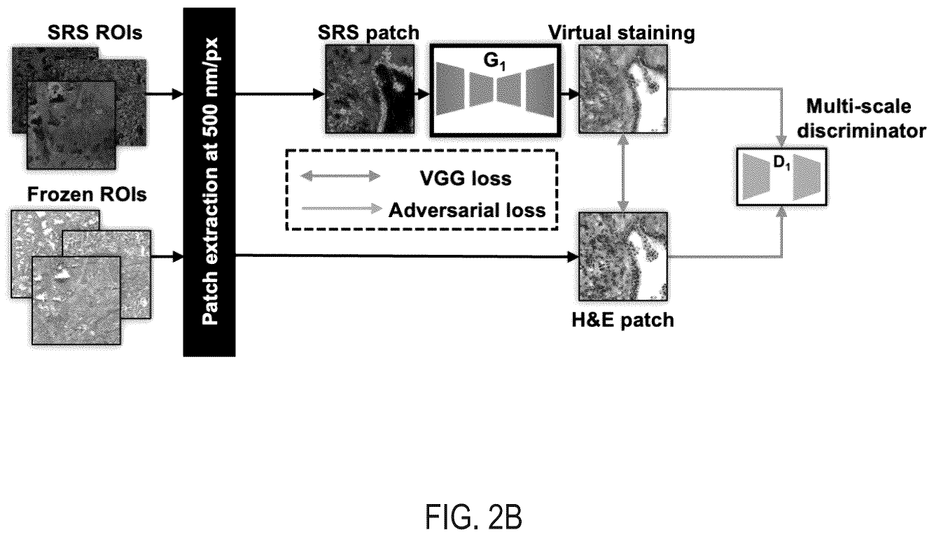

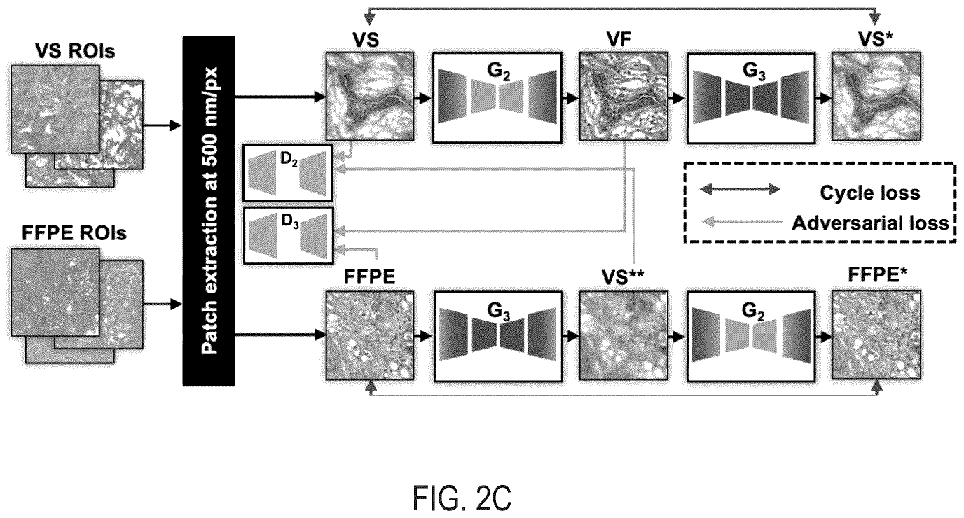

FIGS. 2A-2C depict an example deep-learning framework which converts label-free SRSM images of FF samples to FFPE-like conventional H&E, as described elsewhere herein. As shown in FIG. 2A, this framework includes two generators: G1 and G2. The first model, G1, is the virtual staining model that transforms SRS images into H&E images of FF tissues. As can be seen in FIG. 2B, G1 follows a GAN formulation where its parameters are optimized by minimizing MSE loss and adversarial loss. The second model, G2, enhances the morphology of those virtual staining images and turns them to FFPE-like samples. Since the FF and FFPE images are not paired, the embodiments herein utilize cycle-GAN to train G2 based on an unpaired dataset, as shown in FIG. 2C. A third model, G3, maps images from the FFPE domain to FF and may be used as part of the cycle-GAN methodology. For calculating the adversarial loss, the embodiments herein used multi-scale discriminators where there are two discriminators that have an identical layout, which may then be applied to different image scales. In summary, one of the two discriminators operates on the full resolution images whereas the other one operates on the down-sampled images by factor of two. In addition, both generators may follow a modified U-Net architecture.

The generator G1 was trained in two phases. In phase 1, the MSE loss function between the G1's output and the real FF H&E ground truth was minimized for 50,000 iterations. However the results using the MSE loss function alone were blurry and overly smooth. To compensate for this, G1 was retrained in phase 2 using the pretrained model in phase 1 and optimizing weights using a GAN formulation (as depicted in FIG. 2B) for 200,000 more iterations using batch size of 9, according to the following equation:

$${ℒ}_{{G}_{1}} = {ℒ}_{VGG} * α + {( 1 - {D}_{1} ( {G}_{1} ( SRS ) ) )}^{2} * γ$$

In the above, [symbol] is perceptual loss that is calculated by MSE of feature maps produced by a pretrained VGG-19 model. α and γ in the above equation are regularization terms to stabilize the training, which were set to 0.01 and 0.005 respectively, though other values are possible. The discriminator loss is defined as:

$${ℒ}_{{D}_{1}} = {( 1 - {D}_{1} ( Frozen H \& E ) )}^{2} + {D}_{1} ( {{G}_{1} ( {G}_{1} ( SRS ) )}^{2}$$

The embodiments herein may involve training the virtual FFPE model using a cycle-GAN framework. As shown in FIG. 2C, there may be two loss functions: cycle loss and adversarial loss. Cycle loss is defined as:

$${ℒ}_{cycle} \{ {G}_{2} , {G}_{3} \} = ‖ {G}_{3} ( {G}_{2} ( VS ) ) - VS {‖}_{1} + ‖ {G}_{2} ( {G}_{3} ( FFPE ) ) - FFPE {\vert \vert}_{1}$$

In the above, VS is the virtual staining image resulting G1. The adversarial loss for translating VS to FFPE is defined as:

$$\begin{matrix}{ℒ}_{adv} \{ {G}_{2} \} = {( 1 - {D}_{2} ( {G}_{2} ( VS ) ) )}^{2} , and \\ {ℒ}_{adv} \{ {D}_{2} \} = {( 1 - {D}_{2} ( FFPE ) )}^{2} + {{D}_{2} ( {G}_{2} ( VS ) )}^{2}\end{matrix}$$

Similarly, for mapping from FFPE to VS, [symbol] {G₃} and [symbol] _{adv} {D₃} are calculated in the same way. The overall objective function is defined as:

$${ℒ}_{total} \{ {G}_{2} , {G}_{3} , {D}_{2} , {D}_{3} \} = {ℒ}_{adv} \{ {D}_{2} , {D}_{3} , {G}_{2} , G {}_{3} \} + {γ}_{1} ℒ {}_{cycle} \{ {G}_{2} , {G}_{3} \}$$

In the above, γ1 is a regularization term and set to 10. The virtual FFPE framework may, in some embodiments, be trained for 100,000 iterations and with a batch size of 6.

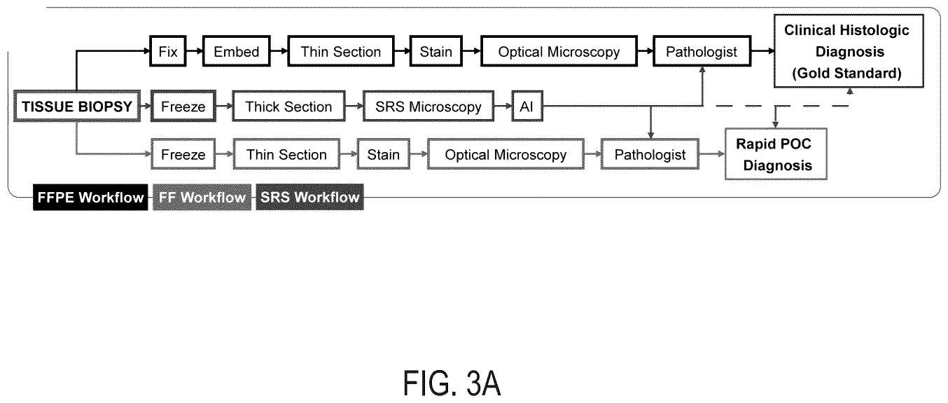

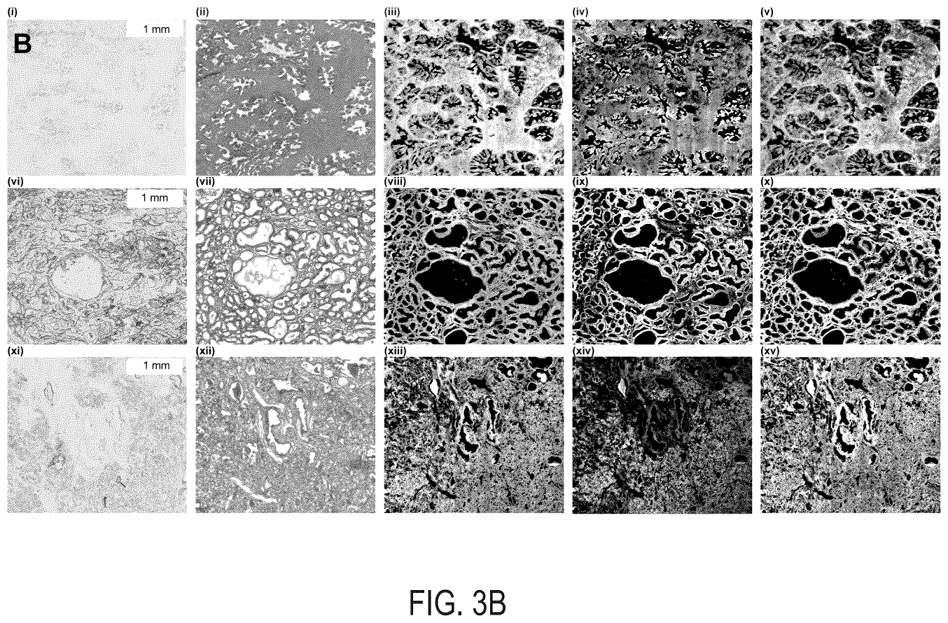

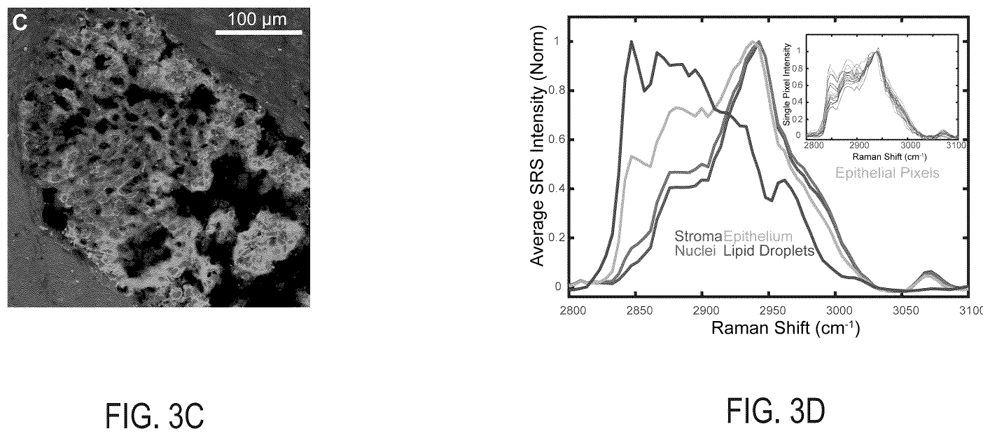

An overview of the approach herein and results in FIGS. 3A-3x. The comparison of the proposed workflow with current processes is presented in FIG. 1A. The proposed SRS-based histopathologic workflow (middle) includes two major changes—first, the use of relatively thick tissue sections that are easier to cut than thin sections. Second, dispensing with the need for staining by using AI. Notably, this workflow seeks to generate both FF and FFPE images of thin sections from thick sections, providing the pathologist with high-quality images.

To illustrate this workflow, FIGS. 3B-3x examine images from different contrast mechanisms first. As with all tissues, unstained histologic sections may have very little contrast in brightfield microscopy, as depicted in items (i), (vi), and (xi) in FIG. 3B. Stains may highlight specific features, as shown in items (ii), (vii), and (xii) in FIG. 3B, which highlight glandular and stromal patterns that become appreciable due to the contrast between the nuclei largely found in epithelial cells (staining blue with hematoxylin) nestled in the protein-rich stroma and extracellular matrix (staining pink with eosin).

From H&E-stained images, pathologists may identify different morphologic patterns of epithelial cells (Gleason grades) that are known to be correlated with PCa severity and outcome. In SRSM, chemically-sensitive images from protein, nucleic acid and lipid composition may be directly generated without any dyes or stains. Items (iii), (viii), and (xiii) in FIG. 3B show the overall tissue composition at 2933 cm⁻¹. Items (iv), (ix), and (xiv) in FIG. 3B highlight the epithelium at 2847 cm⁻¹. Items (v), (x), and (xv) in FIG. 3B highlight the stroma at 2979 cm⁻¹.

Dual frequency SRS images may be presented with SRS2933-SRS2847 as false color blue images (mimicking DAPI stains of nuclei) and SRS2847 as false color green images mimicking actin stains, as presented for a zoomed-in section of a gland in FIG. 3C, highlighting the nuclei and stroma (blue) and cytoplasm of epithelial cells (green).

While using SRSM data to produce H&E images has been demonstrated, generating realistic staining patterns for a wide variety of cells is difficult due to subtle morphologic and contextual differences. For example, nuclei of basal epithelial cells are morphologically distinct from mature epithelial cells. There are also spectral differences across voxels that arise from underlying biological and functional differences, biochemical heterogeneity even in physiologically-identical cell types, sampling differences and noise. FIG. 3D depicts the average normalized spectra from tissue compartments. First, differences in these spectra illustrate the powerful potential of spectroscopic imaging to segment cells and subcellular domains. Second, the heterogeneity of composition even in this small set from a single sample (inset figure, epithelial pixels) presents the challenge of simply using spectral markers for segmentation. The AI-based approach herein harnesses spectral differences between cell types as well as overcomes within-cell type variations using spatial-spectral methods with DL.

Specific SRSM frequency bands were chosen for analyses. The importance of candidate bands was determined by considering their biological significance and their ability to reconstruct the whole spectra using a regression model. To convert these multiband discrete frequency SRS images to clinical images, two DL frameworks were developed that include two convolutional neural networks (CNN) generator models: G1 and G2, as depicted in FIG. 2A. G1 transforms SRS images into H&E images of FF processed tissues. As shown in FIG. 2B, G1 follows a GAN formulation wherein its parameters are optimized by minimizing mean square error (MSE) and adversarial loss, as discussed above. The second model G2 enhances contrast to simulate the results of tissue processing and, additionally, mitigates FF sample artifacts to convert the morphology of those virtual FF-stained images to archival-quality FFPE-like ones. An additional challenge in developing these models was that FF and FFPE images cannot be acquired from the same sample, i.e., are not paired. For this reason, cycle-GAN was used to train G2 based on an unpaired dataset, as depicted in FIG. 2C.

The training and test datasets for G1 included imaged regions of interest (ROIs) from 70 FF prostate samples. For training, ROIs from 31 (25 stained using the same sections and 6 stained using adjacent sections) samples were used, resulting in 5,023 patches of 500 pixels×500 pixels. The remaining 39 samples were used for testing. This dual-sample type strategy allows a highly precise “matched” set that provides the ability to precisely compare stained and generated images whereas adjacent sections provide a slight diversity that is expected to make training more robust. The SRS and FF H&E images may be correlated for G1 training. Since staining introduces tissue deformation and some stained images are from adjacent sections, perfect pixel level registration may not be straightforward. To correct this, one option is to develop sophisticated alignment algorithms with deformation, translation and rotation models. However, it is unclear if that approach can provide precise alignment universally. Instead, the embodiments herein macroscopically aligned the SRS and H&E images using control points over the whole section while understanding that there will be some noise in the correlations that will result from small misalignments. Matched patches were used as inputs for training using 200,000 iterations, as described above.

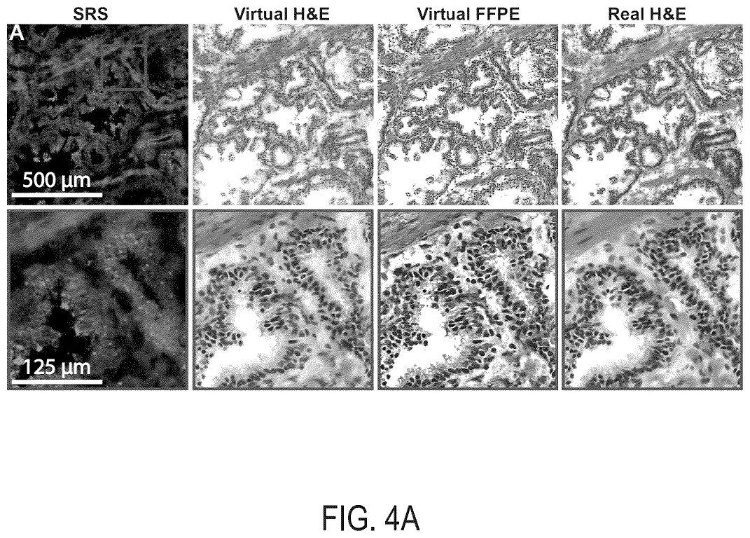

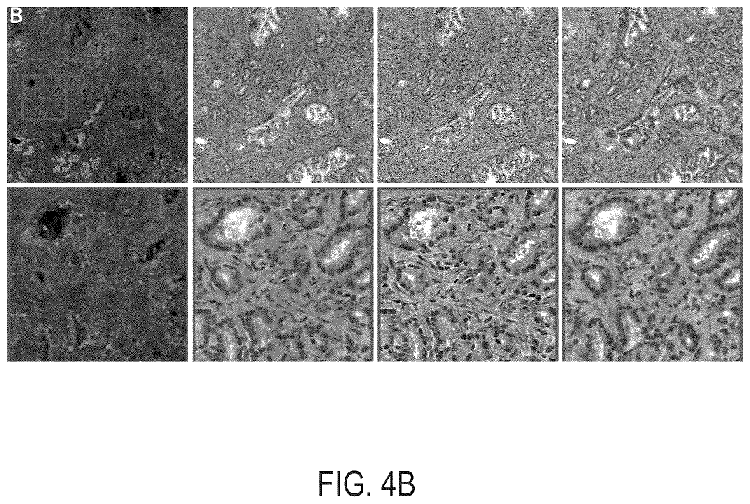

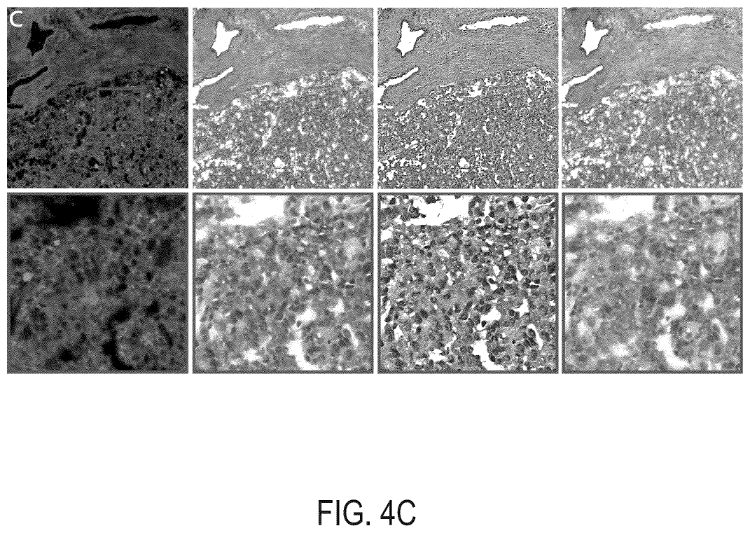

The performance of the framework presented herein was evaluated by using SRS images from patients that were not a part of the training and testing sets (i.e., blinded external validation). FIGS. 4A-4C illustrate the results for three major representative pathologies. From left to right, chemical images, the generated FF H&E image, virtual FFPE H&E image, and corresponding stained images are shown. Two-color SRS images are presented as described above in relation to FIG. 3C. FIG. 4A compares virtual and H&E images for normal tissue with open glands in stroma with polarized epithelial cells. FIG. 4B depicts an example of a low-grade cancer (Gleason grade 3 and below), in which crowded, filled-in but identifiable glands, enlarged epithelial nuclei and dense stroma can be identified. FIG. 4C depicts an example of a high-grade cancer (Gleason Grade 4 and 5) in which the lack gland formation and heterogeneity of nuclear signals can be readily appreciated. Examination of all samples in the data set showed similar performance, with key hallmarks of disease severity being appreciable.

Obtaining thin slices from FF tissue requires skill, experience and can lead to artifacts that may confound accurate diagnoses. The optical sectioning capability of SRS can mitigate such artifacts by confocal imaging of thicker tissue slices. This potential is demonstrated herein by imaging relatively thick sections that are easier to cut and less prone to artifacts (˜50-100 μm) while seeking to obtain thin section-quality images. These sections were imaged across planes at different depths, and the virtual stain images were computationally generated by applying the DL framework described above.

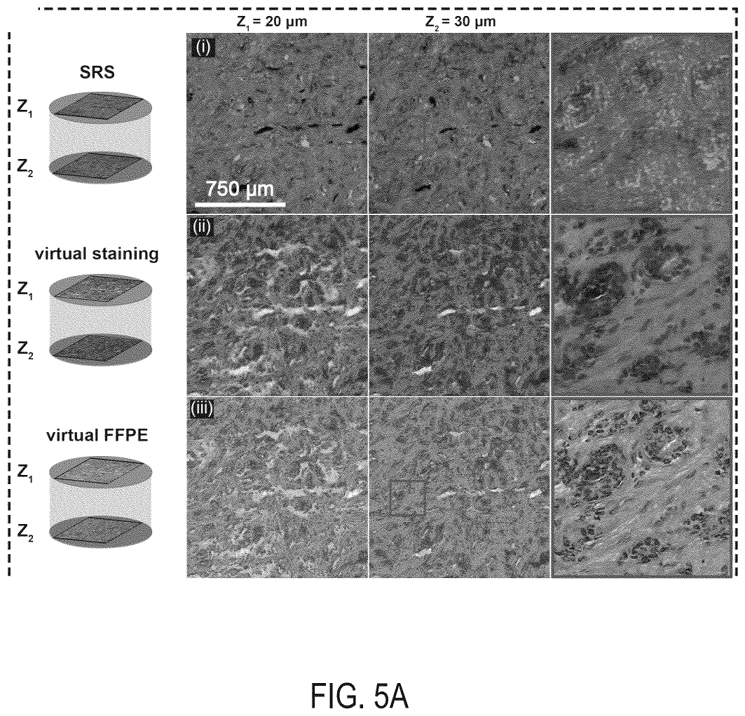

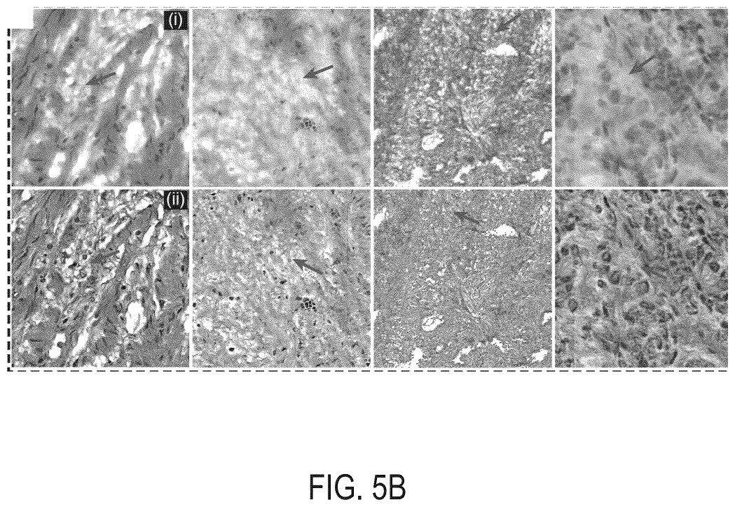

Item (i) of FIG. 5A depicts representative SRS data at two different depths (20 μm and 30 μm) of the thick low-grade prostate cancer section. At this thickness, a diversity in pathology and glandular structures can be seen in a corresponding multi-section virtual stain image, as in item (ii) of FIG. 5A Multi-section virtual staining also allows for a more thorough examination of the sample in limited time settings such as intraoperative pathology. One of the key benefits of multi-section virtual staining is that it may reduce the chance of missing a tumor in histological images. This can occur because tumor cells do not always exist in every section of a tissue sample, and traditional staining methods may only examine a limited number of sections. With multi-section virtual staining, a larger number of sections can be examined, thus decreasing the likelihood of overlooking cancerous regions. Additionally, this approach can also provide a more detailed and accurate understanding of the tumor's size, location, and cellular characteristics, which can be important for diagnosis and treatment planning.

To improve the morphological information and staining contrast of FF images, the embodiments herein include a DL framework G2 to generate FFPE-like images (virtual FFPE) from virtual FF images, as discussed above. The performance of G2 for generating virtual FFPE images given virtual stain images is demonstrated in item (iii) of FIG. 5A. The model is applied to various depths of sample separately to create multi-section virtual FFPE images. To train G2, 25 samples were selected from virtual stain images and 25 samples were selected from real FFPE samples. For training, 4,608 patches of 500×500 were created. It is important to note that after the training phase, the model can recover correct FFPE morphology and contrast without the need for additional information.

FIG. 5B depicts 4 examples of FF artifacts, including staining, freezing, knife cut, and blurring artifacts, which have been mitigated using a virtual FFPE model. These findings indicate that utilizing a virtual FFPE network improves the appearance of FF histological images by increasing the clarity of morphological features, providing more detailed structure, and enhancing color contrast. Notably, the method herein of creating volumetric data eliminates the need for sectioning, staining, and preparing FFPE samples separately. Instead, it may use an SRS system to image thick FF samples, followed by artificial intelligence to create multi-section virtual FFPE images without the need for slicing the samples. This makes the approach herein more efficient and less time-consuming compared to conventional gold standard histopathology.

Additionally, since signal localization depends only on the focal spot and there may still be significant transmission through these thicknesses, there is no expected physical reason for a degradation in image quality compared to the thin section results. Collectively, these results demonstrate both virtual stains and optical sectioning capability in the workflow described herein that is geared to be simpler in sample processing and can result in fewer artifacts.

While the previous sections can facilitate compression of the sample preparation and imaging workflow, SRSM offers an additional advantage. The use of FF tissue sections and minimal processing preserves the native lipid composition of tissues and enables correlative study of lipid droplet (LD) expression with grades of prostate cancer. Upregulation of de-novo lipid biosynthesis leading to accumulation of lipids in the form of droplets has been identified as a potential biomarker for PCa aggressiveness. In order to explore the prognostic value of lipid droplet expression in prostate cancer, SRS images from tissues were analyzed. The images were sourced of a subset of 33 patients divided into three major categories of clinical relevance—of low (Benign through low Gleason patterns (GP), GP<3), of moderate (GP=3) and high clinical concern (GP=4 and 5). Since PCa is a highly multi-focal cancer with multiple Gleason patterns often present in close association, analyses were performed at the level of individual glands or contiguous tumor areas which were unambiguously assignable to a pattern.

In order to evaluate the changes in lipid expression in the stromal cells (fibroblasts, smooth muscles etc), segments of stroma adjacent to glands were chosen with no infiltrating cancer cells, inflammation and other abnormalities. A total of 96 gland patterns of low concern, 56 of moderate, and 61 of high concern were chosen. Further, 119 regions of interest (ROIs) in the stroma were annotated for statistical analyses presented below. From the average spectra of lipid droplets presented above in FIG. 3D a threshold value of the ratio: SRS (2847 cm⁻¹)/SRS (2933 cm⁻¹) was generated for quantifying the presence of lipid droplets.

Additionally, the segmented images were used to calculate lipid droplet density. Analogous to the histomorphic heterogeneity of PCa, the lipid droplet density also shows large overall intra-class heterogeneity (i.e. same pattern in different regions of the tissue and across different patients) for patterns of moderate and high concerns (interquartile range/mean value of 1.7559 and 1.7562 respectively) as compared to that of patterns of low clinical concern (0.9063).

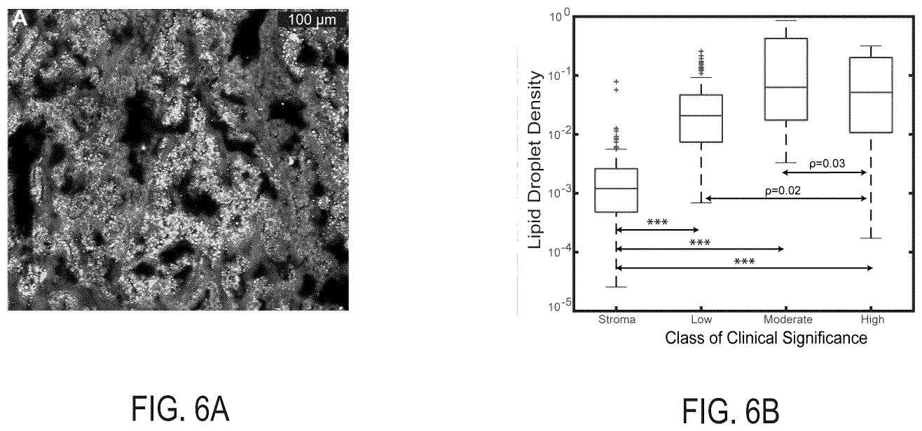

FIG. 6A depicts an example of a cancerous gland showing heterogeneous LD expression, apparent as roughly circular droplets in a GP=5 adenocarcinoma. FIG. 6B depicts the observed lipid droplet density (log scale) for the different classes of clinical significance described above. One way analysis of variance (1-way ANOVA, F=129.62, ρ=2.19011e−55) followed by a post-hoc pairwise unpaired t-test between the groups revealed statistically significant differences (at 5% significance level) in mean lipid droplet densities between all the groups. Interestingly, the cancer glands that lead to moderate clinical concern (GP=3) show the highest levels of lipid droplet distribution followed by those of high clinical concern patterns (GP 4 and 5). In contrast, glands of low clinical concern and stroma showed negligible presence of lipid droplets. Overall, this result demonstrates that although lipid metabolism is upregulated in clinically significant PCa, as evidenced by the higher lipid droplet density, there is significant heterogeneity at the level of individual glands and the correlation with cancer patterns is not monotonic.

What is claimed is:

1. A method comprising:
obtaining a first training dataset that includes stimulated Raman scattering microscopy (SRSM) images of frozen tissue samples;
obtaining a second training dataset that includes optical microscopy images of thawed, stained tissue samples, wherein each optical microscopy image of the second training dataset depicts a respective same frozen tissue sample as a corresponding SRSM image of the first training dataset;
using the first training dataset and the second training dataset to train a first generative model to generate, from input SRSM images of frozen tissue samples, output model-generated images of thawed, stained tissue samples;
using the trained first generative model, generating a third training dataset that includes model-generated optical microscopy images of thawed, stained tissue samples;
obtaining a fourth training dataset that includes formalin-fixed paraffin embedded (FFPE) microscopy images of FFPE tissue samples; and
using the third training dataset and the fourth training dataset to train a second generative model to generate, from input microscopy images of thawed, stained tissue samples, output model-generated images of FFPE tissue samples.

2. The method of claim 1, wherein using the first training dataset and the second training dataset to train the first generative model comprises training the first generative model together with a first discriminator model by:
training the first generative model to generate images of the second training dataset based on corresponding images of the first training dataset; and
training the first discriminator model to predict whether an input image is an output generated by the first generative model or an optical microscopy image of a thawed, stained tissue sample.

3. The method of claim 1, wherein using the first training dataset and the second training dataset to train the first generative model comprises:
for a first plurality of iterations, pre-training the first generative model to generate images of the second training dataset based on corresponding images of the first training dataset using a pixel-wise squared difference loss function; and
subsequently training the pre-trained first generative model together with a first discriminator model by:
training the pre-trained first generative model to generate images of the second training dataset based on corresponding images of the first training dataset; and
training the first discriminator model to predict whether an input image is an output generated by the first generative model or an optical microscopy image of a thawed, stained tissue sample.

4. The method of claim 1, wherein at least one optical microscopy image of the second training dataset depicts a respective same section of the same frozen tissue sample as the corresponding SRSM image of the first training dataset.

5. The method of claim 1, wherein at least one optical microscopy image of the second training dataset depicts an adjacent slice of a respective same frozen tissue sample as the corresponding SRSM image of the first training dataset.

6. The method of claim 1, wherein using the third training dataset and the fourth training dataset to train the second generative model comprises training the second generative model together with training a third generative model to generate, from input images of formalin-fixed paraffin embedded tissue samples, output model-generated microscopy images of thawed, stained tissue samples by:
applying a first image of the third training dataset to the second generative model to generate a first model-generated FFPE microscopy image;
applying a first image of the fourth training dataset to the third generative model to generate a first model-generated optical microscopy image;
applying the first model-generated optical microscopy image to the second generative model to generate a second model-generated FFPE microscopy image;
applying the first model-generated FFPE microscopy image to the third generative model to generate a second model-generated optical microscopy image;
comparing the first model-generated FFPE microscopy image to the second generated FFPE microscopy image to generate a first loss;
comparing the first model-generated optical microscopy image to the second generated optical microscopy image to generate a second loss; and
updating the second generative model and the third generative model based on the first loss and the second loss.

7. The method of claim 6, wherein training the second generative model together with the third generative model comprises training the second generative model and the third generative model together with a second discriminator model and a third discriminator model by:
using the second discriminator model to predict which of the first image of the third training dataset or the first model-generated optical microscopy image was generated by the first generative model and generating a third loss based on the prediction;
using the third discriminator model to predict which of the first image of the fourth training dataset or the first model-generated FFPE microscopy image was generated by the second generative model and generating a fourth loss based on the prediction; and
updating the second discriminator model and the third discriminator model based on the first loss, the second loss, the third loss, and the fourth loss, wherein updating the second generative model and the third generative model based on the first loss and the second loss comprises updating the second generative model and the third generative model based on the first loss, the second loss, the third loss, and the fourth loss.

8. The method of any of claim 6, wherein comparing the first model-generated FFPE microscopy image to the second model-generated FFPE microscopy image to generate the first loss comprises applying a pixel-wise squared difference loss function, and wherein comparing the first model-generated optical microscopy image to the second model-generated optical microscopy image to generate the second loss comprises applying the pixel-wise squared difference loss function.

9. An article of manufacture including a computer-readable medium, having stored thereon program instructions that, upon execution by a computing device, cause the computing device to perform operations to effect a method comprising:
applying a stimulated Raman scattering microscopy (SRSM) image of a frozen tissue sample to a first generative model to generate an intermediate image, wherein the first generative model has been trained to generate, from input SRSM images of frozen tissue samples, output model-generated optical microscopy images of thawed, stained tissue samples; and
applying the intermediate image to a second generative model to generate a model-generated formalin-fixed paraffin embedded (FFPE) microscopy image of the frozen tissue sample, wherein the second generative model has been trained to generate, from input optical microscopy images of thawed, stained tissue samples, output model-generated images of FFPE tissue samples.

10. The article of manufacture of claim 9, wherein the method further comprises:
obtaining the SRSM image by using an optical sectioning method to image the frozen tissue sample along a plurality of image planes within the frozen tissue sample, thereby generating the SRSM image of one of the plurality of image planes and at least one additional SRSM image for at least one additional image plane of the plurality of image planes.

11. The article of manufacture of claim 10, wherein the method further comprises applying a second SRSM image of at least one additional SRSM image to the first generative model to generate an additional intermediate image; and
applying the additional intermediate image to the second generative model to generate an additional model-generated FFPE microscopy image of the frozen tissue sample.

12. The article of manufacture of claim 9, wherein the method further comprises:
sectioning the frozen tissue sample into a slice having a thickness greater than 50 microns; and
obtaining the SRSM image by using an optical sectioning method to image the slice along at least one image plane within the slice.

13. The article of manufacture of claim 9, wherein the SRSM image includes seven or fewer bands of wavelengths of stimulated Raman scattering image data.

14. The article of manufacture of claim 13, wherein the seven or fewer bands of wavelengths of stimulated Raman scattering image data are selected from a set of bands of wavelengths consisting of: 2923-2943 cm⁻¹, 2837-2857 cm⁻¹, 2868-2888 cm⁻¹, 2969-2989 cm⁻¹, 2891-2911 cm⁻¹, 2950-2970 cm⁻¹, 3052-3072 cm⁻¹, 3001-3021 cm⁻¹, 3029-3049 cm⁻¹, 3075-3095 cm⁻¹, 2983-3003 cm⁻¹, 2937-2957 cm⁻¹, and 2909-2929 cm⁻¹.

15. The article of manufacture of claim 13, wherein the seven or fewer bands of wavelengths of stimulated Raman scattering image data are selected from a set of bands of wavelengths consisting of: 2923-2943 cm⁻¹, 2837-2857 cm⁻¹, 2868-2888 cm⁻¹, 2969-2989 cm⁻¹, 2891-2911 cm⁻¹, 2950-2970 cm⁻¹, and 3052-3072 cm⁻¹.

16. The article of manufacture of claim 9, wherein the SRSM image includes five or fewer bands of wavelengths of stimulated Raman scattering image data.

17. The article of manufacture of claim 16, wherein the five or fewer bands of wavelengths of stimulated Raman scattering image data include at least one of: 2923-2943 cm⁻¹, 2837-2857 cm⁻¹, 2868-2888 cm⁻¹, 2969-2989 cm⁻¹, and 2891-2911 cm⁻¹.

18. The article of manufacture of claim 9, wherein the first generative model and the second generative model have been trained using the method of claim 1.

19. The article of manufacture of claim 9, wherein the method further comprises:
determining, based on the SRSM image of the frozen tissue sample, a lipid content of the frozen tissue sample; and
providing, on a display, an indication of the determined lipid content of the frozen tissue sample and an indication of the model-generated FFPE microscopy image of the frozen tissue sample.

20. An article of manufacture including a computer-readable medium, having stored thereon program instructions that, upon execution by a computing device, cause the computing device to perform operations to effect a method comprising:
applying a stimulated Raman scattering microscopy (SRSM) image of a frozen tissue sample to a generative model to generate a model-generated formalin-fixed paraffin embedded (FFPE) microscopy image of the frozen tissue sample, wherein the generative model has been trained to generate, from SRSM images of frozen tissue samples, output model-generated images of FFPE tissue samples.
